(19) United States
(12) Patent Application Publication
(10) Pub. No.: US 2024/0378251 A1
(43) Pub. Date: Nov. 14, 2024

(54) GUIDED CONTENT GENERATION USING PRE-EXISTING MEDIA ASSETS

(71) Applicant: Google LLC, Mountain View, CA (US)

(72) Inventor: Charles Baxter Boyd, Santa Clara, CA (US)

(21) Appl. No.: 18/659,776

(22) Filed: May 9, 2024

Related U.S. Application Data
(60) Provisional application No. 63/501,191, filed on May 10, 2023.

(51) Int. Cl. G06F 16/9535

(52) U.S. Cl. CPC G06F 16/9535

(57) ABSTRACT

Methods, computing systems, and technology for automatically generating media assets and content items are presented. The system can receive data indicating a request for a plurality of media assets that comprise multiple media modalities. Additionally, the system can obtain a media asset profile for a client account associated with the request. Moreover, the system can generate, using a machine-learned media asset generation pipeline, the plurality of media assets based on the media asset profile by instructing a machine-learned asset generation model to generate media assets that align with the media asset preferences. Furthermore, the system can send, based on receiving data indicating selection of one or more of the plurality of media assets, the one or more of the plurality of media assets to a content item generation system for generating content items using the one or more of the plurality of media assets.

### PRIORITY

The present application claims the benefit of priority of U.S. Provisional Patent Application No. 63/501,191, filed on May 10, 2023, which is incorporated by reference herein.

### FIELD

The present disclosure relates generally to automatically generating content items or media assets based on a profile or preference of a user.

### BACKGROUND

A communication campaign can leverage a multi-modal, multi-platform distribution system to distribute content items to various endpoints for various audiences. The content items can contain data or other information or messages. The content items can be or include media assets. A user can create a communication campaign by providing the multi-modal, multi-platform distribution system with a set of content items for distribution.

### SUMMARY

Aspects and advantages of embodiments of the present disclosure will be set forth in part in the following description, or can be learned from the description, or can be learned through practice of the embodiments.

One example aspect of the present disclosure is directed to a computing system for generating content items. The computing system can include one or more processors and one or more non-transitory computer-readable media. The computer-readable media can collectively store a machine-learned generation model, a machine-learned selection model, and instructions. The machine-learned generation model can be configured to generate a plurality of content items. The machine-learned selection model can be configured to select a selected content item from the plurality of content items. The instructions, when executed by the one or more processors, cause the computing system to perform operations. The operations can include receiving, from a user device of a user, user input associated with a web resource. The web resource can be associated with an account of the user. The operations can include extracting a plurality of assets from the web resource, wherein each asset in the plurality of assets is an image, a word, a video, or an audio file. The operations can include processing, using the machine-learned generation model, the plurality of assets to generate the plurality of content items. The operations can include determining, using the machine-learned selection model, the selected content item from the plurality of content items. The operations can include causing the presentation of the selected content item on a graphical user interface displayed on the user device.

In some instances, the operations can further include receiving a user interaction on the graphical user interface, the user interaction modifying the selected content item. Additionally, the operations can include processing, using the machine-learned generation model, the user interaction, and the selected content item to generate a modified content item. Moreover, the operations can include causing the presentation of the modified content item on the graphical user interface displayed on the user device. Furthermore, one or more parameters of the machine-learned generation model can be updated based on the user interaction.

In some instances, the operations can further include receiving a user interaction on the graphical user interface. The user interaction can be associated with rejecting the selected content item. Additionally, the operations can include processing, using the machine-learned selection model, the plurality of content items and the user interaction to generate a new content item. Moreover, the operations can include causing the presentation of the new content item on the graphical user interface displayed on the user device.

In some instances, the operations can further include receiving a user interaction on the graphical user interface, the user interaction accepting the selected content item. Additionally, the operations can include determining, using a machine-learned model, an advertisement campaign based on the selected content item. Moreover, the operations can include causing the presentation of the advertisement campaign on the graphical user interface displayed on the user device.

In some instances, the web resource can be a website, and the user input is a Uniform Resource Locator (URL) of the website.

In some instances, the plurality of content items can include a first content item, and the first content item can be generated by modifying an image asset of the plurality of assets. Additionally, the plurality of content items can include a second content item, and the second content item is a generative image generated by the machine-learned generation model using the image asset.

In some instances, the operations can further include calculating, using the machine-learned selection model, a conversion score for each content item in the plurality of content items, the conversion score indicating the likelihood that a user interacts with the respective content item. For example, the selected content item can be the content item with the highest conversion score in the plurality of content items.

Another example aspect of the present disclosure is directed to a computing system. The system can include one or more processors and one or more non-transitory computer-readable media storing instructions that are executable by the one or more processors to cause the computing system to perform operations. The operations can include receiving data indicating a request for a plurality of media assets that comprise multiple media modalities. Additionally, the operations can include obtaining a media asset profile for a client account associated with the request. The media asset profile can include data indicating media asset preferences for the client account. The media asset profile can be generated by processing pre-existing media assets associated with the client account. Moreover, the operations can include generating, using a machine-learned media asset generation pipeline, the plurality of media assets based on the media asset profile by instructing a machine-learned asset generation model to generate media assets that align with the media asset preferences. Furthermore, the operations can include sending, based on receiving data indicating selection of one or more of the plurality of media assets, the one or more of the plurality of media assets to a content item generation system for generating content items using the one or more of the plurality of media assets.

In some instances, the multiple media modalities include two or more modalities selected from: text, image, or audio.

In some instances, the operations can further include generating data for the media asset profile by parsing a web resource associated with the client account.

In some instances, the operations can further include parsing the web resource to extract the pre-existing media assets from the web resource.

In some instances, the operations can further include parsing the web resource to extract visual style data associated with the client account. For example, the visual style can include color information, layout information, or typography information.

In some instances, the operations can further include parsing the web resource to extract textual style data associated with the client account. The textual style data can include an intonation or inflection of copy on the web resource.

In some instances, the operations can further include parsing the web resource to extract landing page data associated with the client account. The landing page data can include URLs to web pages associated with the plurality of media assets.

In some instances, the media asset profile was retrieved from a database, and the media asset profile was previously generated prior to the request.

In some instances, the operations can further include generating at least one of the plurality of media assets by editing a pre-existing image asset using at least one of the following editing operations: crop, rotate, infill, recolor, defocus, deblur, denoise, relight. The editing operations are optionally implemented with machine-learned image editing tools. Additionally the pre-existing image asset can be edited based on historical performance data associated with image assets. Moreover, the pre-existing image asset can be edited based on a set of content item guidelines for generating content items using the pre-existing image asset.

In some instances, the operations can further include inputting, to a machine-learned media asset generation model, data from the media asset profile and a request for generated assets consistent with the data from the media asset profile.

In some instances, the operations can further include determining, using a machine-learned performance estimation model, one or more generated assets, wherein the machine-learned performance estimation model is configured to identify asset characteristics associated with historical performance data. Additionally, the operations can further include generating, using the machine-learned performance estimation model, an augmented input for input to the machine-learned media asset generation model to induce asset characteristics associated with historical performance data. Moreover, the operations can include ranking, using the machine-learned performance estimation model, the generated assets from the machine-learned media asset generation model.

In some instances, the operations can further include presenting, on a user interface accessible by the client account, one or more generated media assets for review. Additionally, the operations can include receiving, via the user interface, inputs providing corrections to the one or more generated media assets. Moreover, the operations can include re-generating, using the machine-learned media asset generation pipeline, the one or more generated media assets based on the received inputs. Furthermore, the user interface can include one or more selectable input elements associated with the one or more generated media assets and indicating a corresponding corrective action to be performed with respect to the one or more generated media assets. The selectable input elements can be configured to provide, upon selection, the received inputs. The user interface can include a natural language input element for receiving corrective inputs in natural language format, where the natural language input element is configured to provide the received inputs.

In some instances, the media asset profile can be based on at one or more features of the following features, the one or more features being associated with the client account: a machine-learned model, images, sitemap, logo, social media accounts, asset library, performance data, past sets of media assets, past sets of generated media assets.

In some instances the plurality of media assets can include two or more categories of the following categories: images, headlines, descriptions, videos, logos, colors, sitelinks, calls to action, audio.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a diagram of a machine-learned media asset generation pipeline according to example embodiments of the present disclosure.

FIG. 2 depicts a flow diagram of a media asset generation process according to example embodiments of the present disclosure.

FIG. 3 depicts a flow diagram of a media asset generation process according to example embodiments of the present disclosure.

FIG. 4 depicts a flow diagram of a media asset generation process according to example embodiments of the present disclosure.

FIGS. 5A-C depicts diagrams of a machine-learned media asset generation pipeline according to example embodiments of the present disclosure.

FIG. 6 depicts a graphical user interface for receiving user input according to example embodiments of the present disclosure.

FIG. 7-11 depict components of a machine-learned media asset generation pipeline according to example embodiments of the present disclosure.

FIGS. 12A-12C depict graphical user interfaces associated with the asset feedback layer according to example embodiments of the present disclosure.

FIGS. 13A-13B depict graphical user interfaces associated with the asset feedback layer according to example embodiments of the present disclosure.

FIG. 14 depicts a graphical user interface associated with the asset feedback layer according to example embodiments of the present disclosure.

FIG. 15 depicts a graphical user interface associated with the asset feedback layer according to example embodiments of the present disclosure.

FIG. 16 depicts a graphical user interface associated with the asset feedback layer according to example embodiments of the present disclosure.

FIG. 17 depicts a graphical user interface associated with the asset feedback layer according to example embodiments of the present disclosure.

FIG. 18 depicts a flow diagram of different platforms associated with the output of the machine-learned content item generation pipeline according to example embodiments of the present disclosure.

FIG. 19A depicts a block diagram of an example computing system that performs guided content generation according to example embodiments of the present disclosure.

FIG. 19B depicts a block diagram of an example computing device that performs guided content generation according to example embodiments of the present disclosure.

FIG. 19C depicts a block diagram of an example computing device that performs guided content generation according to example embodiments of the present disclosure.

FIG. 20 depicts a flow chart diagram of an example method to generate media assets according to example embodiments of the present disclosure.

FIG. 21 depicts a flow chart diagram of an example method to generate media assets according to example embodiments of the present disclosure.

Reference numerals that are repeated across plural figures are intended to identify the same features in various implementations.

### DETAILED DESCRIPTION

### Overview

Generally, the present disclosure is directed to automatically generating content items or media assets based on a profile or preference of a client. Example implementations provide for generating, using a machine-learned media asset generation pipeline, a plurality of media assets based on a media asset profile by instructing a machine-learned asset generation model to generate media assets that align with media asset preferences of the client. Further, example implementations of the present disclosure relate generally to generating, using machine-learned models, content based on information extracted from a website. For example, a user can input a web address into the system, and the system can generate content for the user based on data extracted using the web address. Example techniques include automatically generating a plurality of content items for a communication campaign and selecting a content item from the plurality of content items based on a prediction of how well the selected content item will perform in the communication campaign.

For example, a client can be a user associated with a user account. The user can interact with a campaign generation system to create a new communication campaign. The user can interact with the campaign generation system using a user account. The campaign generation system can associate the user account with a set of campaign preferences, which can include a set of media asset preferences. If the user account is associated with other communication campaigns, the media asset preferences can include preferences obtained based on those other campaigns (e.g., preferences directly received via input from user account, preferences learned implicitly from user account actions).

The new communication campaign can communicate data directing audiences to a data resource associated with the campaign. The data can be or include a resource locator (e.g., URI, URL, deep links, app links). The data resource can be a web resource (e.g., web page, web application), a local resource (e.g., native application running on a client device).

The user can provide the resource locator of the data resource to the campaign generation system. The user can provide this early in the campaign generation process, such as when initiating the generation of the new campaign. The campaign generation system can process the resource locator to identify the data resource and obtain data from and about the data resource. For instance, for a campaign pointing to a web page, the campaign generation system can use a provided URL to load the target web page, parse or crawl the page to extract pre-existing media assets (e.g., images, text, video, color palette, typography) and learn a theme, style, entity branding associated with the target web page. Other related resources can be parsed. A sitemap can be used to parse resources on a document tree on which the data resource resides. The system can parse resources that are linked on the data resource, such as based on a relevance measure of the linked resources.

With regards to brand understanding, after the user enters their website, campaign goals, and audiences, the system, using a machine-learned model, can automatically infer brand elements from all available information, such as social, video channels, public information, past published content, past sponsored content, and so on. The machine-learned model can generate assets and sponsored content based on the initial understanding of the brand, presenting them to the users for feedback. Users can review, edit, and complete their brand profile, by manual input or uploading existing brand guidelines or more references, like past sponsored content, and mood boards. After a user has refined their brands, the system can present assets and sponsored content reflecting the change. In some instances, a plurality of brands can be associated with a single user. For example, a user can create a new brand profile or switch between profiles to manage seasonal campaigns or campaigns for different audiences.

According to some embodiments, the system can automate the generation of brand-centered content items. The system enables content providers to deliver on-brand creatives quickly and at-scale. The system can generate brand-centered content items by enhancing images and videos, improving asset quality to, auto generated assets in a plurality of formats. The system can generate brand specific assets (e.g. a pharmaceutical store can have a different format than a kids store), the system can also create a unified creative brand intelligence that allows it to seamlessly provide on-brand creatives to all content providers. Brand sensitive content provider, by providing user feedback, can adjust brand parameters and achieve on-brand assets and formats without risking their performance.

The system can generate personalized brand-centered campaigns by understanding the brand and applying the brand to creatives. With regards to understanding the brand, the system can ensure that the assets (e.g., image assets) have a consistent look and feel across all channels based in part on a set of brand elements for the brand that is created by the machine-learned models. In some instances, the core brand elements are unlikely to change frequently. Additionally, the system can generate ephemeral brand signals to an existing brand to meet seasonal needs or for specific campaigns that want to slightly deviate from the core brand elements. The brand signals can be generated for one campaign, a season, or for a specific promotional campaign. Subsequently, the system can apply a brand to creatives. For example, brand-sensitive content providers can add brand elements and adjust brand parameters to achieve on-brand assets and formats without compromising their performance. This will help content providers trust the automated creatives more and lead to greater adoption.

In some instances, an entity brand can encompass the following key elements to define its identity and influence creative strategy. First, the overall story element can include position and uniqueness information, target audience information, and value information. Second, the visual identity element can include logo information, typography information, color palette information, and aesthetics (e.g., imagery and photography, custom graphics or patterns, layout, design elements (e.g., curves/lines)). Third, the verbal identity element can include tone of voice information and taglines information.

The campaign generation system can predict the resource locator to prefetch content for improved latency. For instance, for a user account with known associations to a known resource locator, the campaign generation system can use the known resource locator to begin parsing the data resource even before the user confirms the resource locator.

The campaign generation system can prefetch content for improved latency by beginning to parse the data resource as soon as the resource locator is input to an input field, even if the user has not yet completed other input fields on the same interface screen. In this manner, for instance, by the time the user progresses to the next input screen, the parsing operation is well underway or already complete, thereby reducing latency for the user.

Data parsed from the data resource can be used to update the media asset preferences. The campaign generation system can use the media asset preferences to form or update an account profile that describes a communicative personality for the account (e.g., brand personality), account assets, performance data from any past campaigns, and learned features of relevant audiences and learned trends or features of a group of communicators as a whole. This account profile can be maintained dynamically as campaigns are distributed and updated, as campaign communications are received and used by the recipient endpoints. The account profile can be updated dynamically as the user interacts with the machine-learned media asset generation pipeline to save a current progress, current preferences, selections, inputs, signals.

The campaign generation system can collect additional input signals from the user. The input signals can refine predicted or pre-populated features of the account profile or media asset preferences. For instance, based on the data parsed from the data resource, the campaign generation system can predict initial goals for the communication campaign, general themes and styles, and other data resources relevant to the communication campaign. The user can refine, update, approve, or reject these predictions by providing additional input signals.

The additional input signals can include a product/service name, product/service description (e.g., a freeform, multiline input where the user specifies details about their product/service) that can be suggested or pre-populated, brand traits (e.g., adjectives that describe the brand) that can be suggested for a point-and-click interface, and/or social media opt-ins (e.g., permissions to obtain assets from social media platforms associated with the user account). Machine-learned models can provide prefills for one or more of the input fields for the signals based on the account profile or the parsed data resource. A threshold can be used to prefill when a confidence level is exceeded (e.g., corresponding to a quality of prefill).

The additional input signals can be persisted in association with the user account. The additional input signals can be persisted in association with assets generated based on the additional input signals. The additional input signals can include metadata indicating whether a particular signal was manually modified by a user. This persisted signal data can be resurfaced to the user if the user, in the future, creates another related campaign. For instance, if the user creates a campaign regarding the same or similar data resource, the signal data can be resurfaced without first re-parsing the data resource. This can improve latency and decrease processing requirements. The signal data can be used as an input to the machine-learned asset generation pipeline when parsing the data resource. A subset of the signal data can be used as an input to the machine-learned asset generation pipeline, such as just the signals that have been manually confirmed/modified. In this manner, for instance, the machine-learned asset generation pipeline can learn from user inputs/corrections and avoid making the same errors with respect to future campaigns.

The campaign generation system can process data parsed from the data resource, the account profile data, and the additional input signals to obtain media assets for use in the communication campaign. The campaign generation system can implement a machine-learned media asset generation pipeline to retrieve or modify pre-existing media assets, generate new media assets, or retrieve new media assets from a database, guided by the account profile data and additional input signals. For instance, the machine-learned media asset generation pipeline can generate images, headlines, descriptions, videos, logos, color palettes, sitelinks, and visual styles and themes. The machine-learned media asset generation pipeline can retrieve or modify pre-existing images, headlines, descriptions, videos, logos, color palettes, sitelinks, and visual styles and themes. The machine-learned media asset generation pipeline can query relevant databases (e.g., stock media asset databases) to obtain new images, headlines, descriptions, videos, logos, color palettes, sitelinks, and visual styles and themes.

The machine-learned media asset generation pipeline can retrieve or modify pre-existing media assets. The machine-learned media asset generation pipeline can parse the data resource to extract any content of the data resource. The content from the data resource can be modified or optimized. For instance, images or videos can be resized, text overlays on images or videos can be removed and infilled (e.g., using machine-learned inpainting models), images or videos can be edited (e.g., exposure, coloration, sharpness). Text media assets can be rephrased and edited for clarity. Logos can be identified, rescaled, optimized for overlays (e.g., removing a background, generating an alpha channel), and/or recolored. Other pre-existing assets can be obtained from a media library associated with the account. The media library can include assets used in past campaigns, assets uploaded or generated but not yet used.

The machine-learned media asset generation pipeline can generate media assets using one or more machine-learned models. The machine-learned media asset generation pipeline can use a machine-learned natural language understanding model to parse text on the data resource to understand the content of the data resource and learn about the context in which the content is presented (e.g., a style or theme of the data resource). The machine-learned media asset generation pipeline can obtain a set of asset generation instructions that can be based on or include any one or more of: a representation of the content and its context, the account profile, the media asset preferences, the additional new input signals.

The campaign generation system can reference an allowlist to determine if a user account is approved to use the machine-learned media asset generation pipeline. For instance, campaigns relating to products in sensitive verticals can bypass automatic asset generation and request manual control by the user. For instance, the user can be asked to provide manual inputs and controls to generate assets using machine-learned media asset generation pipeline. The user can be locked out of the machine-learned media asset generation pipeline entirely.

The machine-learned media asset generation pipeline can use a machine-learned image generation model to process the asset generation instructions to generate images that are based on and align with the asset generation instructions. Various image generation architectures can be used, including convolution neural networks, transformers, generative adversarial networks, diffusion models. The image generation models can process, as example inputs, images from the data resource to prompt the models to generate similar images, text descriptions of desired images and other signals or instructions, learned soft prompts. For instance, product images from the data resource can be provided to the image generation model(s) to prompt the model(s) to include the product in the generated images, to outpaint around the product in a new environment. This is one example of a technique to contextualize or re-contextualize product imagery while improving faithful reproduction of the product attributes. Other example techniques for image asset generation include processing assets from the data resource to extract attributes (subjects, colors, mood), using a machine-learned language model to generate a prompt based on the asset generation instructions and the extracted attributes, and inputting the prompt or the asset generation instructions and the prompt to the image generation model.

The machine-learned media asset generation pipeline can use a text generation model to process the asset generation instructions to generate text that is based on and aligns with the asset generation instructions. Various text generation architectures can be used, including convolution neural networks, transformers, generative adversarial networks, diffusion models. An example architecture includes encoder-only, encoder-decoder, or decoder-only transformer-based models trained over large text corpora. The text generation models can process, as example inputs, images from the data resource to prompt relevant descriptions, textual prompts describing desired output text and other signals or instructions, learned soft prompts.

In some examples, the text generation models can process the resource locator, text from the data resource, freeform text provided by the user or generated by the asset generation pipeline (e.g., using a prompt generator), existing text assets associated with the user account, tone and brand indicators (e.g., adjectives or other descriptors associated with the brand, such as may be obtained from the additional signal inputs). The text generation model(s) can be configured to classify the text assets (e.g., as a call to action, promotional phrase, description). A quality of the generated asset can be evaluated (e.g., by the generation model itself, by a quality control model). This can be used for later ranking/selection of the text assets. For instance, a quality measure can include evaluating a relatedness or groundedness with respect to the data resource (e.g., evaluating whether “contactless delivery” is a phrase that accurately describes the content of the data resource). For existing text assets, the campaign generation system can process the existing text assets together with any of the above-noted inputs to rewrite the assets (e.g., change tone).

The machine-learned media asset generation pipeline can use a video generation model to process the asset generation instructions to generate videos that are based on and align with the asset generation instructions. Various video generation architectures can be used, including convolution neural networks, transformers, generative adversarial networks, diffusion models, continuous or discrete time cascaded diffusion models.

The machine-learned media asset generation pipeline can use an audio generation model to process the asset generation instructions to generate audio that is based on and aligns with the asset generation instructions. Various audio generation architectures can be used, including convolution neural networks (e.g., processing spectrograms), transformers (e.g., processing sequences of audio data or embeddings thereof), generative adversarial networks, diffusion models, continuous or discrete time cascaded diffusion models.

The machine-learned media asset generation pipeline can use a machine-learned prompt generator model to generate prompts for input to other generative models in the pipeline. The machine-learned prompt generator model can be trained end-to-end with one or more of the other generative models to increase performance. The prompt generator model can include a language generation model (e.g., a “large language model”). The machine-learned media asset generation pipeline can prompt the generative models with a variety of different prompts to obtain a variety of different outputs. For instance, an output layer of the prompt generation model can be sampled (e.g., randomly sampled, top-K sampled) to obtain an assortment of prompt outputs. This assortment can be input to the corresponding generative models to generate a variety of outputs related to the instructions. The prompt generator can receive a user-provided prompt and rewrite the prompt based on expressive symbolism or imagery (e.g., “progress”→“a person climbing a mountain”). For instance, the prompt can be rewritten by inputting the original prompt and an instruction to a language generation model (e.g., prompting the model, “suggest an image associated with ‘progress’”). The prompt generator model can receive a user-provided prompt (e.g., obtained in a feedback loop, as described below) or a system-rewritten prompt and expand the prompt to be more performant (e.g., “a person climbing a mountain”→“a person climbing a mountain. photography, detailed, HDR, high resolution, 4K”).

Generated assets can be associated with metadata. For example, image assets created or enhanced using the machine-learned media asset generation pipeline can have metadata stored containing information about which tools/pipelines (and which versions) were used to create or enhance the asset. This can flow to assets derived from a machine-learned media asset generation pipeline created/enhanced asset. “Enhanced” can include optimization/optimized features. In this manner, the campaign generation system can perform analysis on how well the enhancements perform (and possibly test against non-enhanced versions). Further, the campaign generation system can facilitate recall (“takedown”) of generated/enhanced assets (or derived assets) as needed. This can be limited to net-new generated content or to generated content covering major portions (20%+) of the image. For generated images where a prompt is used, the prompt can be saved. Any user-typed prompt can be saved as well as any prompt generated by a prompt generator.

The machine-learned media asset generation pipeline can query relevant databases for assets. For instance, stock photo or video databases can be queried for content similar to assets retrieved from the data resource or generated based on the data resource.

The machine-learned media asset generation pipeline can obtain assets (e.g., generate, modify, query databases) based on learned attribute insights. For instance, a learned attribute insight model can map subjects (e.g., product, topic) to additional content or keywords or features (e.g., attributes) that are associated with higher performance. For instance, an image asset for “dog toys” might be mapped to depictions of the outdoors and sunshine based on a learned relationship leading to higher performance. Such insights can be used for asset generation/modification for assets of any type. Such insights can be used to broaden or narrow search queries for related assets from an asset database. Such insights can also be surfaced to users during the generation workflow for additional information. Such insights can also be provided in prompts (e.g., passed directly to generative models, passed to prompt generators) to improve asset generation.

The machine-learned media asset generation pipeline can optimize obtained media assets. Optimization can include cropping, inpainting, outpainting, upscaling, recoloring, sharpening, or other modifications. Optimization can be implemented by one or more machine-learned optimization models (e.g., image editing models, video editing models, audio editing models). Optimization can be logged in metadata. Optimization steps can be rolled back by reloading a saved state of the asset from the metadata.

The machine-learned media asset generation pipeline can rank obtained media assets. For instance, a machine-learned ranking model can rank obtained media assets based on a likelihood of performance of the media assets in the communication campaign (e.g., a predicted likelihood of a user interacting with a corresponding content item to execute a hyperlink embedded in the content item). The machine-learned ranking model can rank obtained media items based on a relevance to the data resource. The machine-learned asset generation pipeline can generate an embedded representation of the data resource and compare an embedded representation of the obtained media items to determine a relevance. The ranking can be based on a source of the image (e.g., system-generated, crawled from the data resource, user-uploaded). The ranking can be based on an image recognition result (e.g., images recognized to be of a product described on the data resource). The ranking can be based on an alignment with the additional signals input by the user.

Ranking can also be performed based on best practices. A machine-learned ranking model can be trained to identify best practices for media assets. Heuristic-based best practices can also be checked. A best practices score can be provided. The score can be based on an estimated performance lift (e.g., for a particular audience). For instance, it might be determined that positioning a product in the center of a media asset tends to see a measurable increase in website visits.

Based on the ranking, the machine-learned media asset generation pipeline can select a generated asset from the plurality of assets (e.g., new assets and/or the modified assets) in the content database to present to the user. For instance, top-ranked assets can be selected for presentation. A top-K set of assets can be selected. A sampling of assets can be selected from different rank positions (e.g., to be more robust to ranking error).

Obtained assets can be presented differently based on the ranking. For instance, to a threshold ranking, some assets can be prefilled or preselected, such that users can simply confirm the preselection to proceed. Below the threshold ranking, assets can be provided as suggestions for the user to select manually. Similarly, obtained assets can be presented differently based on the asset type. For instance, text assets may be prefilled as described above. In some situations, image assets may not be prefilled.

The campaign generation system can solicit user feedback regarding the obtained media assets. The campaign generation system can provide a user interface presenting the obtained media assets with interactive input elements provided for editing the obtained media assets. The campaign generation system can provide a user interface presenting input fields for providing natural language instructions for changes to be made to the obtained media assets (e.g., “make the flowers look brighter”) or further instructions for generating new media assets based on the candidates presented (e.g., “generate more assets like this asset”). For instance, to generate more assets like a presented asset, the campaign generation system can input, to the corresponding generative model, the existing asset as part of the prompt to generate similar assets. When generating more assets like a previously-generated asset, the prompt used to generate the previously-generated asset can be re-used. One revision option includes inputting, to the model, the existing asset (generated or otherwise) plus a prompt, then outputting multiple options of the asset as revised based on the prompt.

User feedback can be input back into the machine-learned asset generation pipeline to re-generate or re-modify the media assets according to the feedback signals. This can be performed iteratively until the user approves of the media assets.

User feedback can be obtained using a conversational input interface. For instance, a speech or text natural-language input and output interface can be provided to receive user inputs in natural language and implement the requested changes. The system can also generate outputs in natural language to describe the updates that have been performed.

The campaign generation system can output the media assets to a content item generation system. The content item generation system can generate content items using the media assets. For instance, the content item generation system can combine text assets (e.g., headlines, taglines, descriptions) with image assets (e.g., product images, background images) to create a content item for distribution. The content item generation system can generate content items based on a likelihood of utilization of the content item. For instance, utilization of the content item can include interacting with the content item to execute a hyperlink embedding in the content item. For instance, the hyperlink can direct an endpoint device to the data resource using the resource locator.

User feedback and selections can provide training data for improving one or more components of the machine-learned asset generation pipeline. For instance, a loss, reward, or penalty can be based on the user feedback and selections. The campaign generation system can train one or more components of the machine-learned asset generation pipeline to decrease the loss, increase a reward, or decrease a penalty. Training techniques can involve supervised training (e.g., with supervision provided by the user inputs), unsupervised training (e.g., learning patterns of account behavior to optimize outputs based on those patterns), reinforcement learning (e.g., the asset generation pipeline as the reward-seeking agent).

Other model alignment techniques can be used, such as soft prompts. For instance, one or more soft prompts for inputs to any one or more of the generative models can be learned. A soft prompt can be associated with a particular user account or campaign. In this manner, for instance, the asset generation pipeline can be customized to improve performance for individual user accounts, optionally without retraining the entire pipeline in order to do so.

Ranking can be used earlier in the machine-learned asset generation pipeline to triage usage of available processing bandwidth. For instance, prior to generating assets, the instructions for generating the assets can be ranked (e.g., by processing the asset generation instructions and any other inputs with a machine-learned ranking model) and the media asset generation pipeline can generate the top or top K ranked instruction sets. This pre-generation ranker can be trained based on the eventual output of the machine-learned media asset generation pipeline. In this manner, for instance, fewer low-ranked media assets will be generated in the first place by ranking the instructions pre-generation. In this manner also the processing used to generate the media assets can be allocated to higher-priority (e.g., higher ranked) generation tasks.

Generated assets can be processed by a policy check. For instance, a policy check system can evaluate generated output for any sensitive material (e.g., material that is against a platform policy). The generated assets that violate the policy can be screened out and not presented to the user.

A policy check system can be applied on inputs to the campaign generation system (e.g., inputs provided by the user, data parsed from the data resource). The policy check system can screen for personally identifiable information (PII), obscenities, sensitive topics, or other policy-based screening rules. The policy check system can screen any input provided by the user or parsed from the data resource and strike it from further processing in any other model component.

Examples of the disclosure provide several technical effects, benefits, and/or improvements in computing technology and artificial intelligence techniques that involve the use of machine learning algorithms to generate new data, such as images, audio, text, video, or other types of media. The techniques described herein improve the use of generative models by improving the quality of the generated content. The quality of the generated content is tailored specifically to the entity (e.g., company, user) by using data extracted from a web resource of the entity. For example, by using more content-relevant data, the system improves the performance of generative models. Additionally, the system utilizes better training techniques by developing more efficient and effective training techniques that are specific to the entity (e.g., based on data extracted from a web resource of the entity) to reduce the time and resources required to train models. Moreover, the system can incorporate user feedback and provide the feedback, via reinforcement learning or active learning, to generative models that can help the models learn from user preferences and improve over time. Furthermore, the present disclosure can reduce processing by reducing the number of manual inputs provided by a user and by reducing the number of interface screens which must be obtained, loaded, interacted with, and updated. For example, the user may only have to input a web address of a website, and the system can automatically extract content from the website and automatically generate content items for the user.

With reference now to the Figures, example embodiments of the present disclosure will be discussed in further detail.

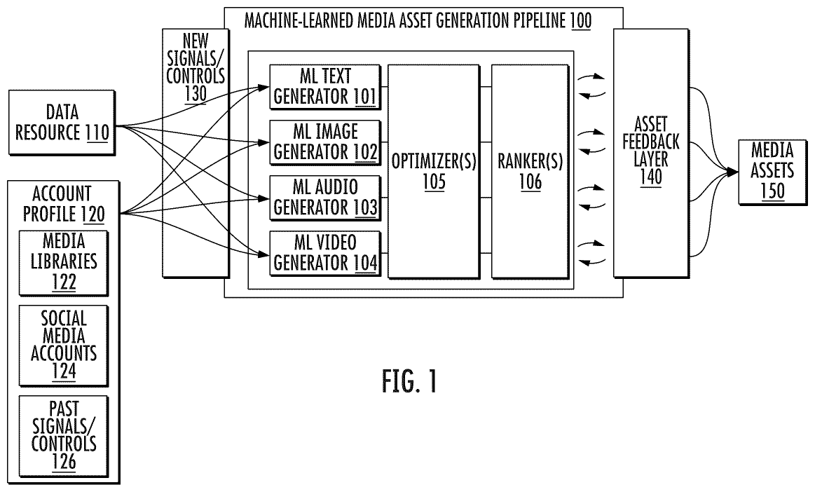

FIG. 1 depicts an example system for implementing a machine-learned media asset generation pipeline 100. Machine-learned media asset generation pipeline 100 can include a machine-learned text generator 101. Machine-learned media asset generation pipeline 100 can include a machine-learned image generator 102. Machine-learned media asset generation pipeline 100 can include a machine-learned audio generator 103. Machine-learned media asset generation pipeline 100 can include a machine-learned video generator 104. Machine-learned media asset generation pipeline 100 can include one or more optimizer(s) 105 to apply one or more optimization algorithms to the outputs of any one or more of machine-learned generator models 101 to 104. Machine-learned media asset generation pipeline 100 can include one or more ranker(s) 106 to rank outputs of any one or more of machine-learned generator models 101 to 104.

Machine-learned media asset generation pipeline 100 can ingest data from a data resource 110 and data from an account profile 120. Account profile 120 can include media asset preferences. Account profile 120 can include media libraries 112. Account profile 120 can include social media accounts 124. Account profile 120 can include past signals/controls 126 input to the machine-learned media asset generation pipeline 100. Machine-learned media asset generation pipeline 100 can process the data retrieved from data resource 110 and account profile 120 according to new signals/controls 130. New signals/controls 130 can include user inputs customizing the media asset generation.

Machine-learned media asset generation pipeline 100 can include an asset feedback layer 140. Asset feedback layer 140 can facilitate input of user feedback on generated assets and initiate generation of updated or different assets. After selection, confirmation, or approval using asset feedback layer 140, machine-learned media asset generation pipeline 100 can output media assets 150. Media assets 150 can include any type of media asset output.

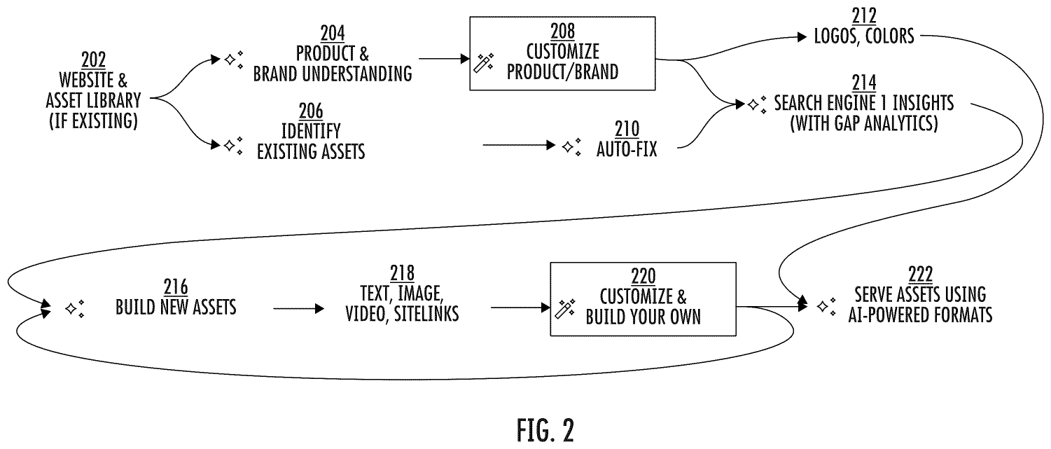

FIG. 2 depicts a flow diagram of an example machine-learned media asset generation pipeline 200 according to example embodiments of the present disclosure. In some instances, the system can receive a website and/or asset library at 202. At 204, the system can determine a product and brand understanding based on the information received and/or obtained at 202. At 206, the system can identify existing assets based on the information received and/or obtained at 202. At 208, the system can customize a product and/or brand based on the determination at 204. At 210, the system can modify (e.g., update) the existing assets that are identified at 206. At 212, the system can determine logos and colors based on the information derived at 208 and/or 210. At 214, the system can determine insights about the company and/or products based on the information derived at 208 and/or 210. At 214, the system can also perform a gap analysis to predict, or auto-generation missing information based on the information derived at 208 and/or 210.

Additionally, at 216, the system can generate new assets based on the information derived at 214. At 218, the system can modify the new asset generated at 216 by adding (e.g., modifying) text, image, videos, and/or sitelinks. The text, image, videos, and/or sitelinks that are selected at 218 can be determined or generated based on information derived at 212 and 214. At 220, the system can receive user input to customize the new assets that are generated at 216 and modified at 218. At 222, the system can serve (e.g., present) the customized assets 220 using AI-powered formats.

The machine-learned media asset generation pipeline 200 can include an overall model. The overall model can be a machine-learned generation model that is configured to generate a plurality of content items. Additionally, or alternatively, the overall model can be a machine-learned selection model that is configured to select a selected content item from the plurality of content items In some implementations, the overall model is trained to receive a set of input data 204 descriptive of a web resource and, as a result of receipt of the input data 204, provide output data 206 that automatically generated new media assets and content items. For example, the system can receive, from a user device of a user, user input associated with a web resource. The system can extract a plurality of assets (e.g., an image, a word, a video, or an audio file) from the web resource. Additionally, the system, using the overall model (e.g., machine-learned generation model), can process the plurality of assets to generate the plurality of content items. Moreover, the system, using the overall model (e.g., a machine-learned selection model), can determine the selected content item from the plurality of content items. Subsequently, the system can cause the presentation of the selected content item on a graphical user interface displayed on the user device.

In another embodiment, the system can receive data indicating a request for a plurality of media assets that comprise multiple media modalities. Additionally, the system can obtain a media asset profile for a client account associated with the request. The media asset profile can include data indicating media asset preferences for the client account, and the media asset profile can be generated by processing pre-existing media assets associated with the client account. The system can generate, using a machine-learned media asset generation pipeline 200, the plurality of media assets based on the media asset profile by instructing an overall model (e.g., machine-learned asset generation model) to generate media assets that align with the media asset preferences. Subsequently, the system can send, based on receiving data indicating selection of one or more of the plurality of media assets, the one or more of the plurality of media assets to a content item generation system for generating content items using the one or more of the plurality of media assets.

According to some embodiments, the system can work alongside a client to curate and create quality, engaging media assets of all kinds for the client's business automatically. Any business, large or small, can start advertising with the system in seconds, even without any assets yet. The system can lower the barrier for all businesses to reach their customers in a personalized and engaging way and democratize advertising creative development for everyone.

The system can combine the best machine learning models, including generative AI, and deep insights to help fill out an entire asset group for most new campaigns automatically in real time. With one click, a client can immediately start with an asset group set to deliver results for client-specific goals, then be able to modify the content items and/or media assets based on suggestions received from the system.

For example, the client can input as much or as little information to generate content items, and as the client generates these content items, the client can in some implementations be able to see the system's assumptions, have the opportunity to make refinements, and accept the media assets (e.g., content items) that the client wants. The client can publish the recommended media assets directly, or just use them as a starting point to customize or build their own.

The system can include a user interface framework for collecting inputs for intelligent asset creation, collection, and combination. The system can surface these assets and the system's assumptions back to clients (e.g., customers). The system can enable refinements of the media assets based on user input, all within the media asset construction process or onboarding flow process.

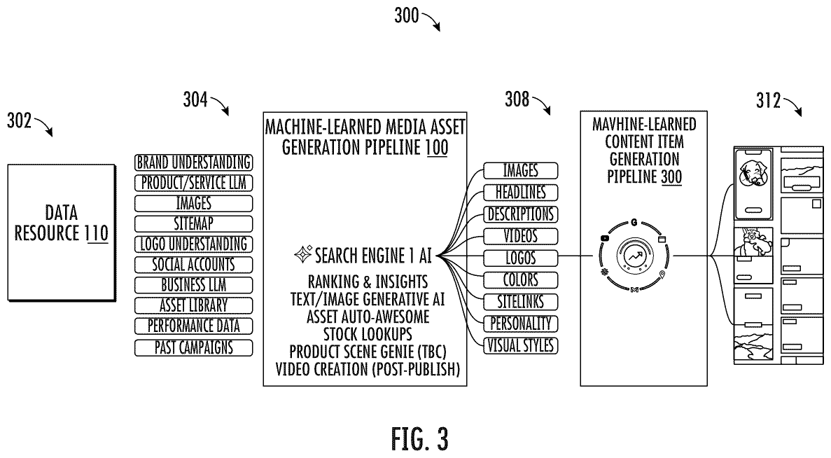

FIG. 3 depicts a block diagram 300 of an example system according to example embodiments of the present disclosure. The system can receive a URL 302 from a user. For example, the system can receive, from a user device of a user, user input associated with the URL. The system can extract a plurality of assets 304 from a data resource 110 associated with the URL 302. The plurality of assets 304 can include brand understanding, product, and service large language model (LLM), images, sitemap, logo understanding, social accounts, business LLM, asset library, performance data, past campaign data. Additionally, the system, machine-learned media asset generation pipeline 100 can process the plurality of assets 304 to generate the plurality of content items 308. The overall model 306 can perform ranking and insights determination, text and/or image generative artificial intelligence, asset auto-generate, stock lockups, product generation, and video creation. The plurality of content 308 can include images, headlines, descriptions, videos, logos, colors, sitelinks, personality, and visual styles. The system can use a machine-learned content item generation pipeline 300 to determine the selected media assets from the plurality of media assets to generate content items 312. Subsequently, the system can cause the presentation of a new content item on a graphical user interface displayed on a user device.

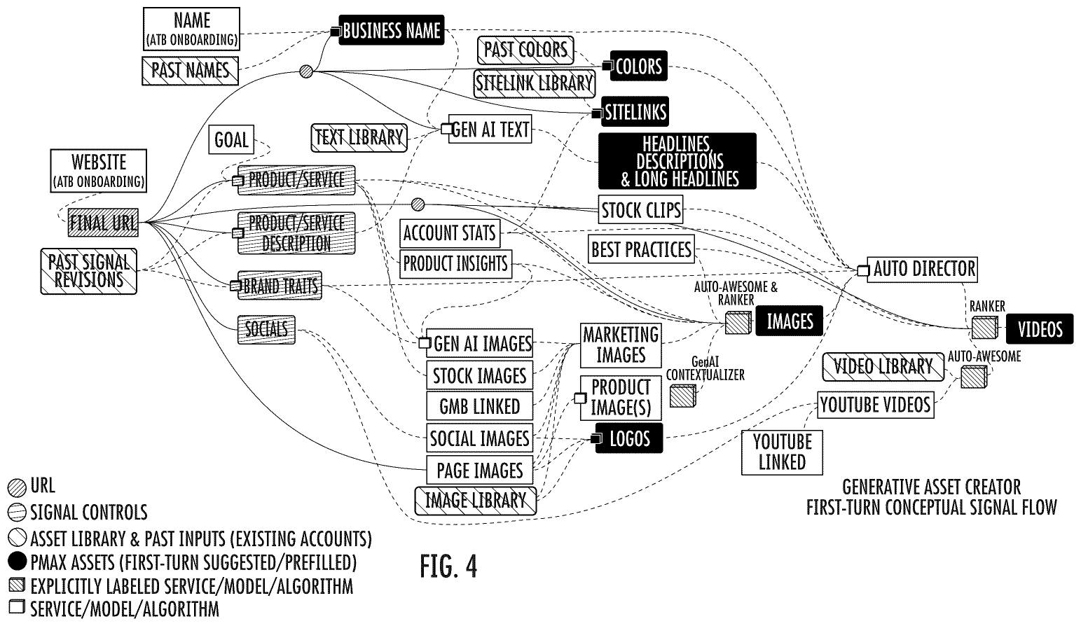

FIG. 4 depicts an example data flow diagram of a forward pass into and through machine-learned media asset generation pipeline 100.

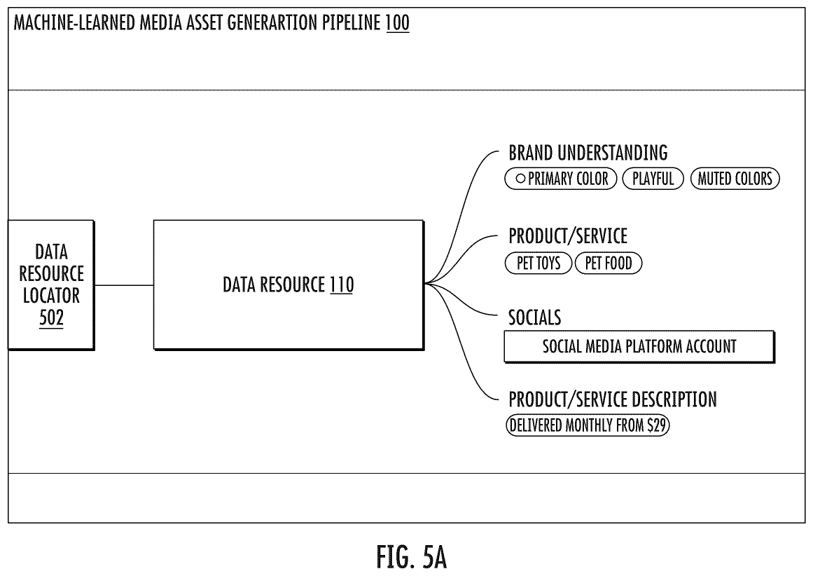

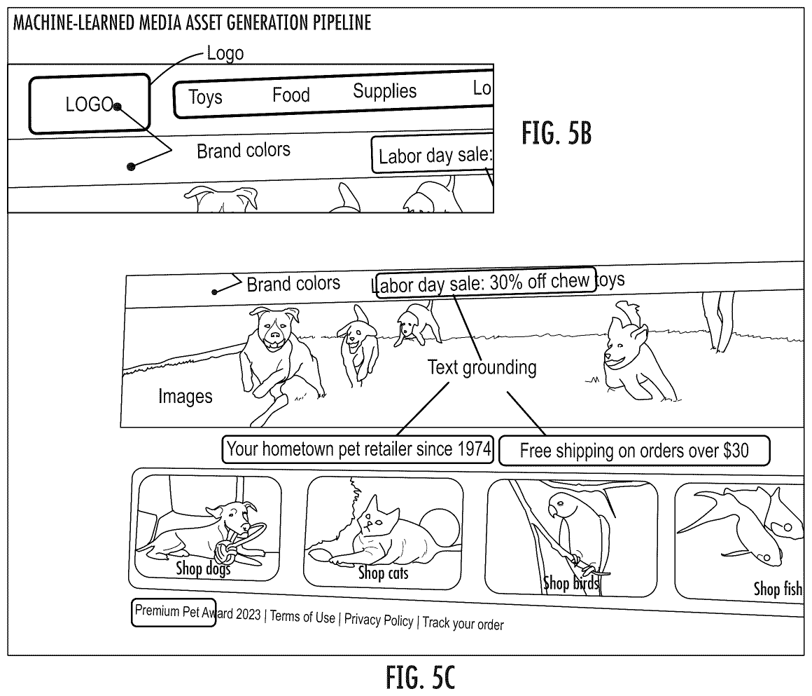

FIG. 5A depicts an example diagram of part of the data flow diagram into and through machine-learned media asset generation pipeline 100. A data resource locator 502 can be a URL or other locator. Using data resource locator 502, various media assets can be extracted from data resource 110, such as brand understandings (e.g., colors, attributes, descriptors), product/service descriptors and other information (e.g., pet toys, pet food, monthly delivery costs), social media information (e.g., extracted from linked social media platform account(s)), and the like.

FIG. 5B and FIG. 5C depict example illustrations of extraction of media assets from a data resource (e.g., a website).

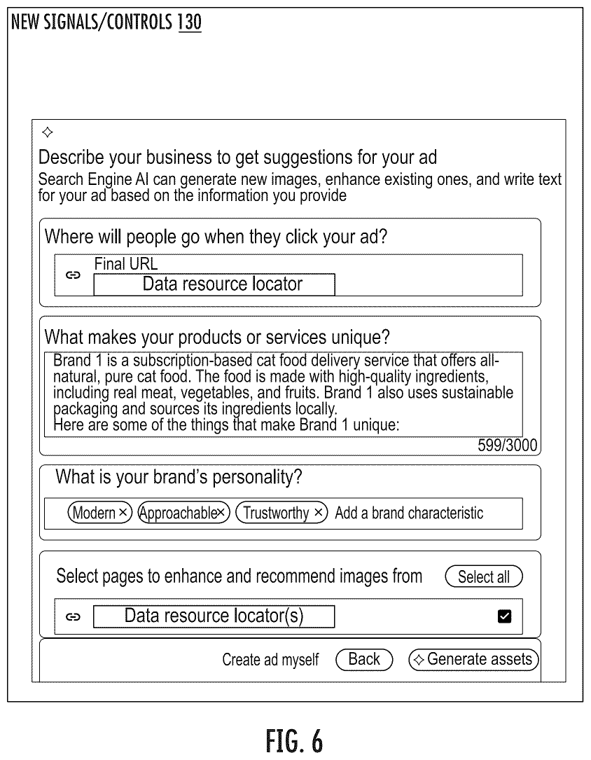

FIG. 6 depicts an example user interface for inputting new signals/controls 130.

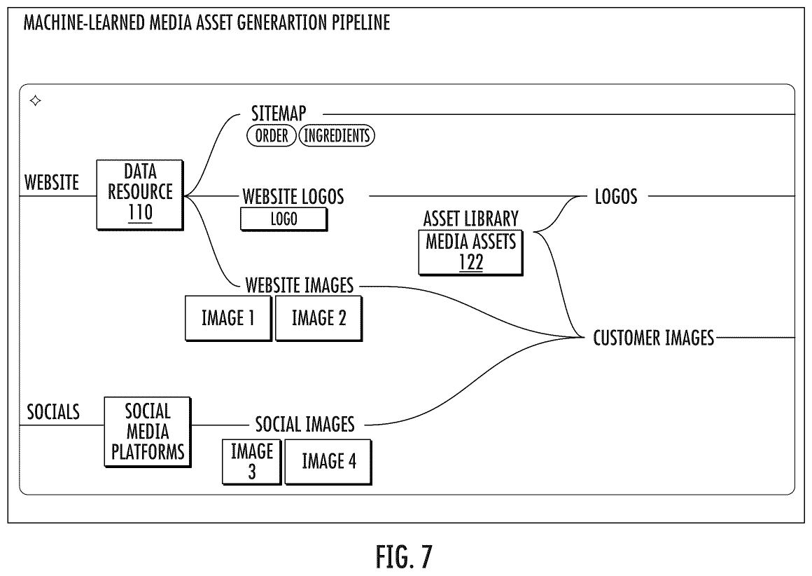

FIG. 7 depicts part of an example data flow into and through machine-learned media asset generation pipeline 100. Machine-learned media asset generation pipeline 100 can extract from data resource 110 sitemap data, logos, images. Machine-learned media asset generation pipeline 100 can extract from linked social media platforms various media, including images.

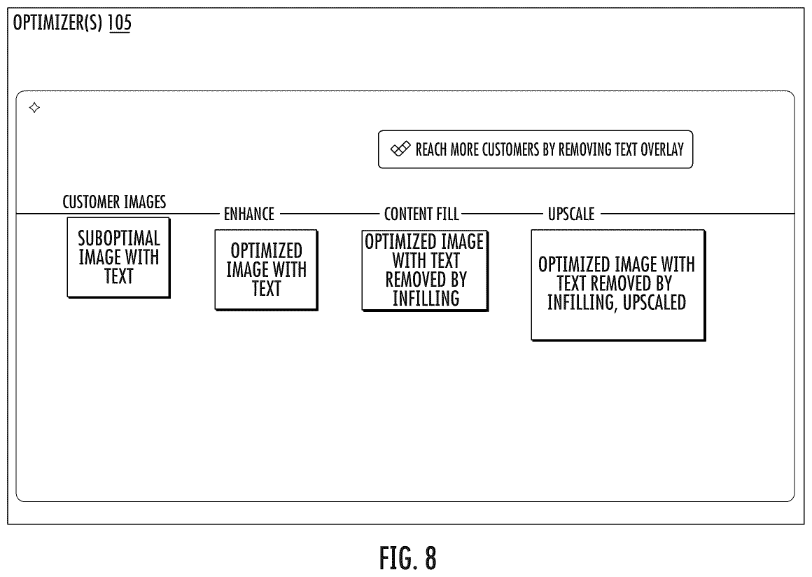

FIG. 8 illustrates an example data flow through optimizer(s) 105 for optimizing an image.

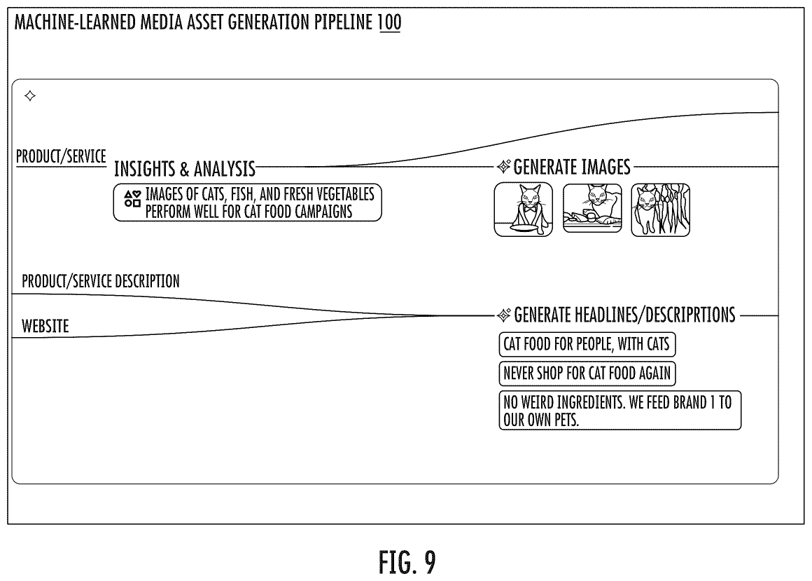

FIG. 9 illustrates an example data flow into and through machine-learned media asset generation pipeline 100.

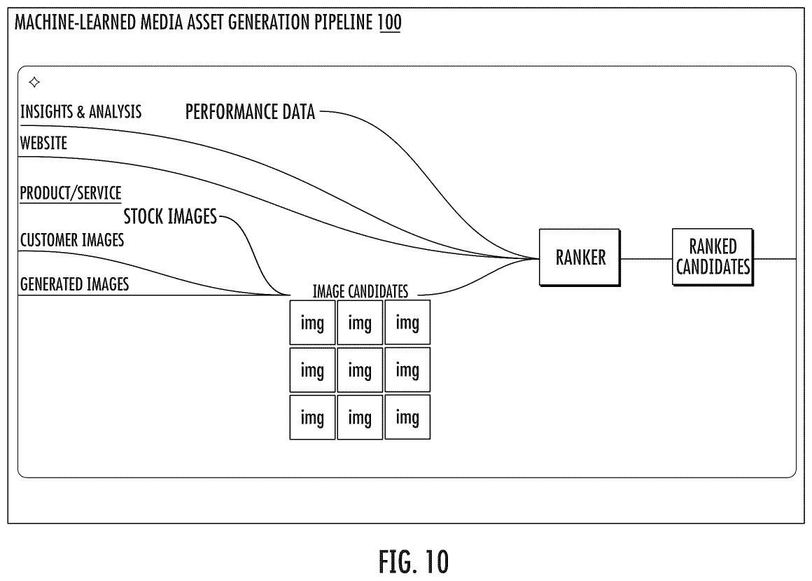

FIG. 10 illustrates an example data flow into and through machine-learned media asset generation pipeline 100.

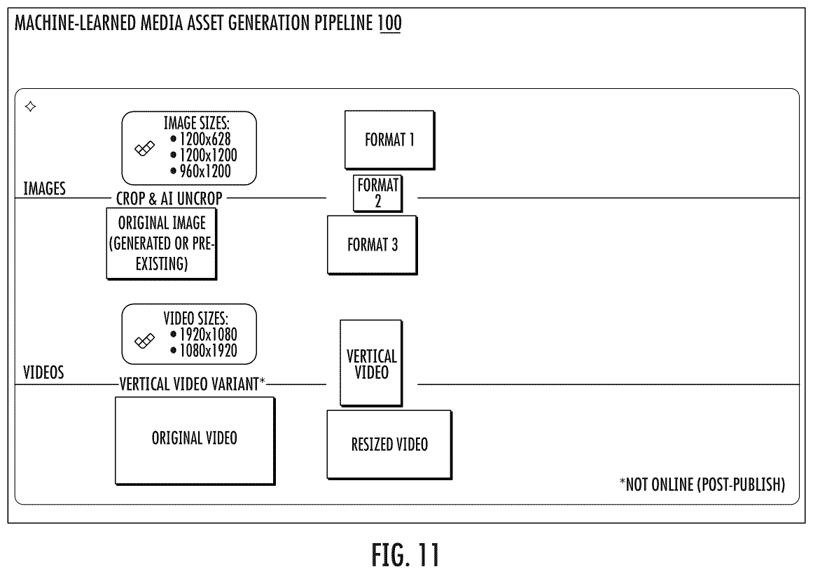

FIG. 11 illustrates an example data flow into and through machine-learned media asset generation pipeline 100.

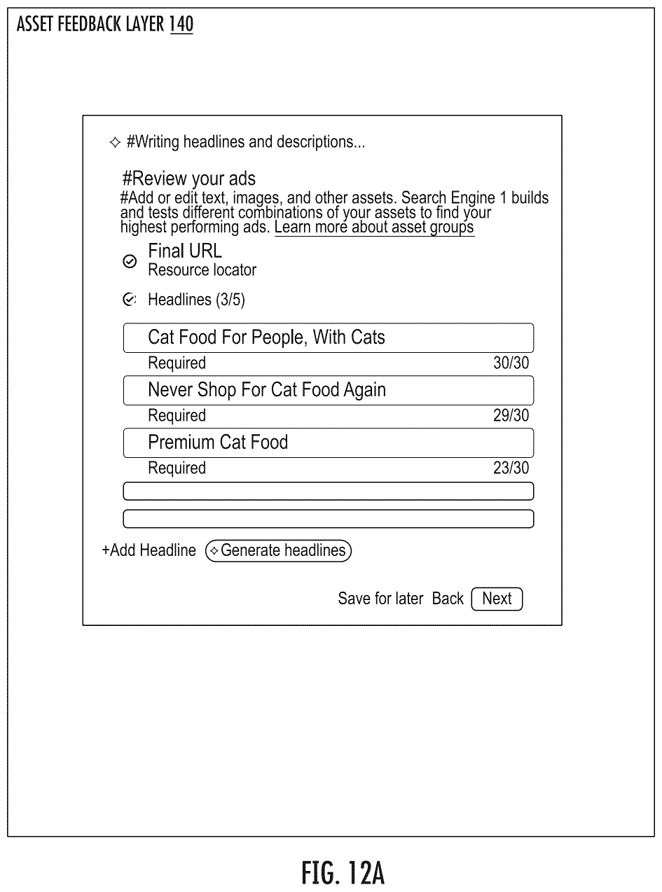

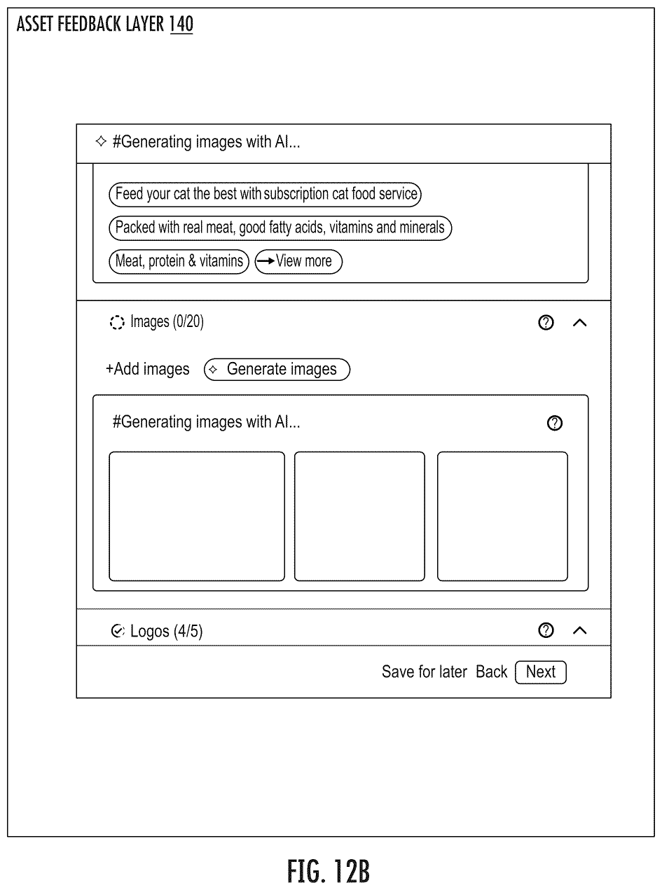

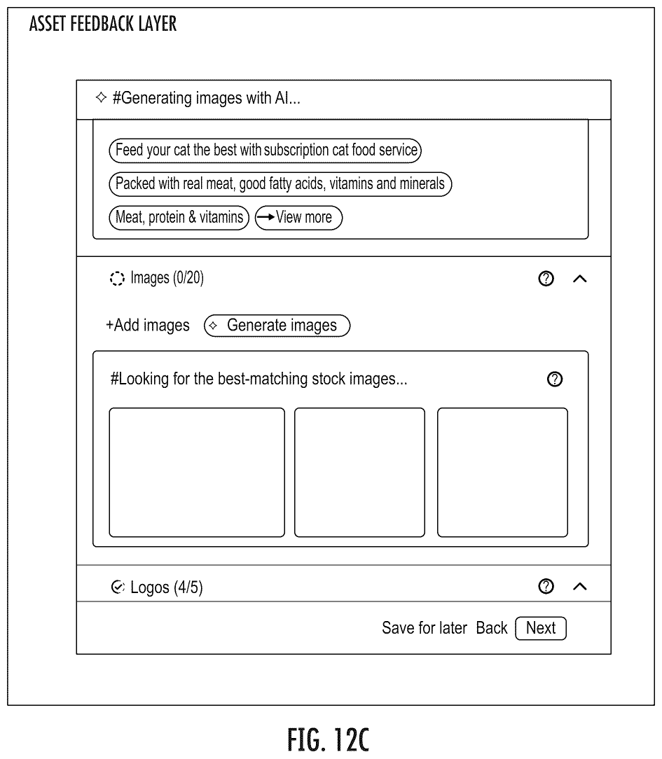

FIG. 12A illustrates an example user interface for interacting with asset feedback layer 140. Asset feedback layer 140 can display loading indicators while receiving generated assets from machine-learned media asset generation pipeline 100 (e.g., solid bars in place of not-yet-loaded text). Asset feedback layer 140 can pre-populate a field of assets with generated assets.

FIG. 12B illustrates an example user interface for interacting with asset feedback layer 140. Asset feedback layer 140 can display loading indicators while receiving generated assets from machine-learned media asset generation pipeline 100 (e.g., solid areas in place of not-yet-generated images). FIGS. 12B and 12C illustrate different loading status messages (e.g., “#Generating images with AI,” “#Looking for best-matching stock images”).

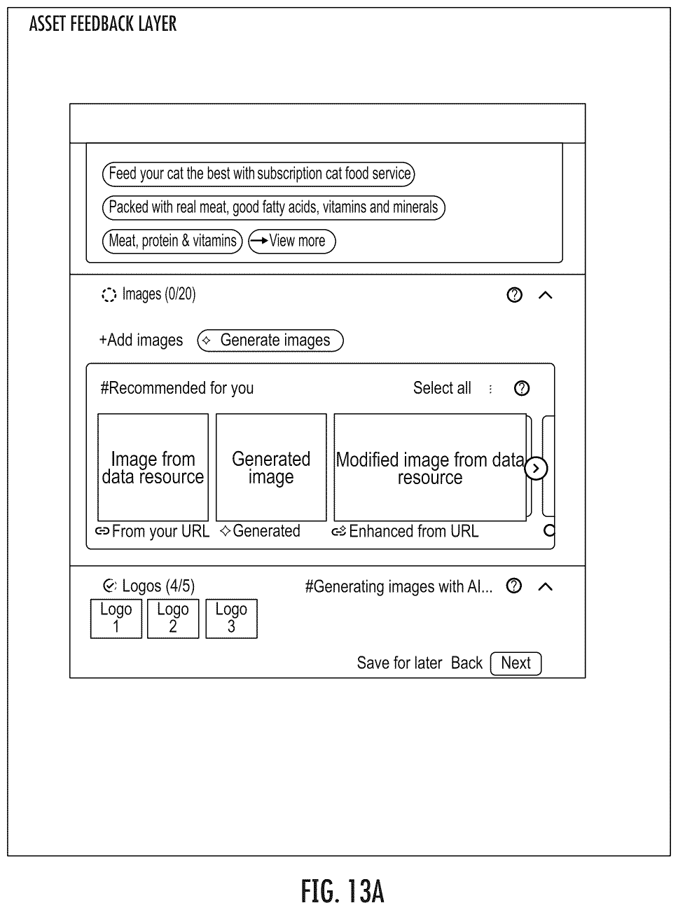

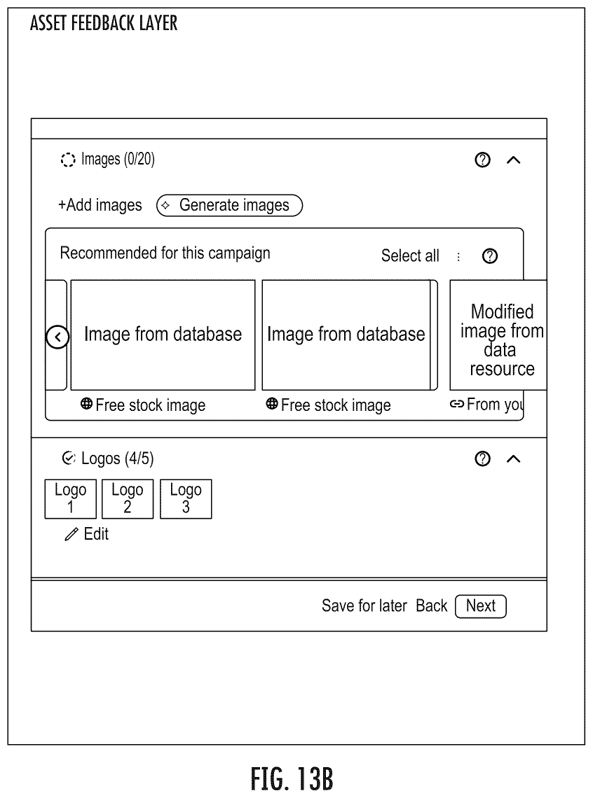

FIG. 13A illustrates an example user interface for interacting with asset feedback layer 140. Asset feedback layer 140 can display obtained media assets along with a source indicator (e.g., “From your URL”).

FIG. 13B illustrates an example user interface for interacting with asset feedback layer 140. Asset feedback layer 140 can display obtained media assets in a scrollable interface (e.g., side-scrolling).

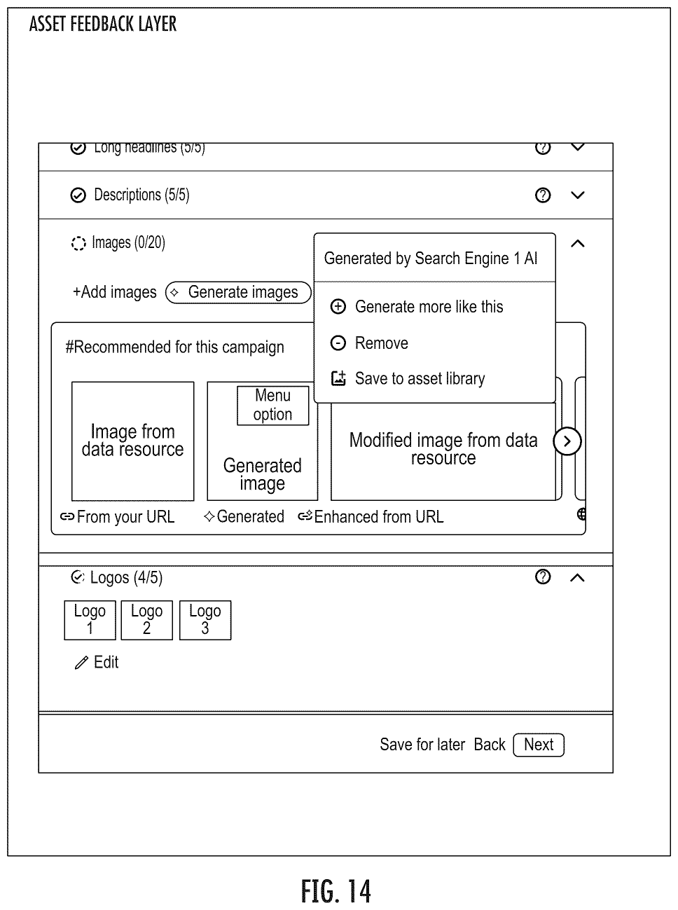

FIG. 14 illustrates an example user interface for interacting with asset feedback layer 140. Asset feedback layer 140 can provide a menu option in association with obtained assets for performing actions in association with the asset.

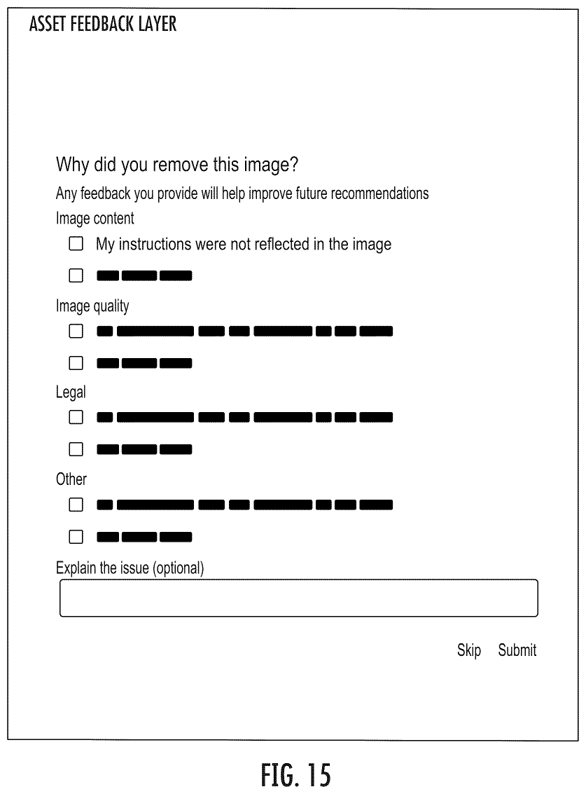

FIG. 15 illustrates an example user interface for interacting with asset feedback layer 140. Asset feedback layer 140 can provide a menu option for removing an asset. Asset feedback layer 140 can provide an interface for providing feedback associated with removal of the asset. The feedback can be used to train one or more components of machine-learned media asset generation pipeline 100.

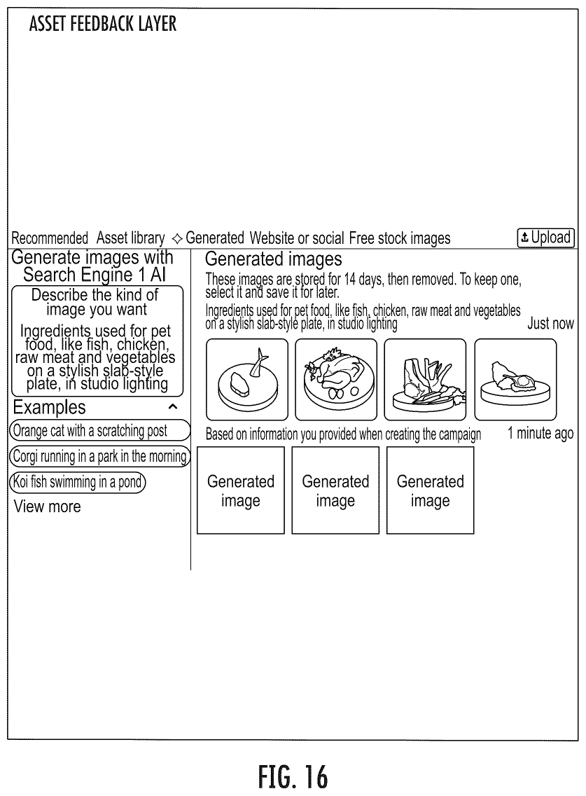

FIG. 16 illustrates an example user interface for interacting with asset feedback layer 140. Asset feedback layer 140 can provide an interface for generating additional assets. Asset feedback layer 140 can provide suggested asset generation prompts, which can be configured to be selectable for initiating processing of the suggested prompt. Asset feedback layer 140 can provide example generated assets. Asset feedback layer 140 can provide an interface for browsing outputs associated with a given prompt. Asset feedback layer 140 can provide an interface for inputting a natural language prompt.

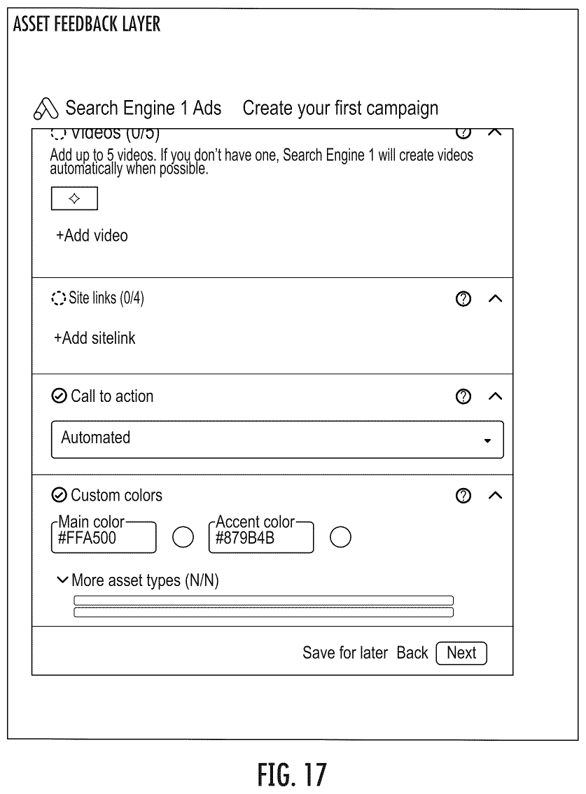

FIG. 17 illustrates an example user interface for interacting with asset feedback layer 140. Asset feedback layer 140 can provide an interface for viewing other extracted and suggested media assets, such as colors, text assets, sitelinks.

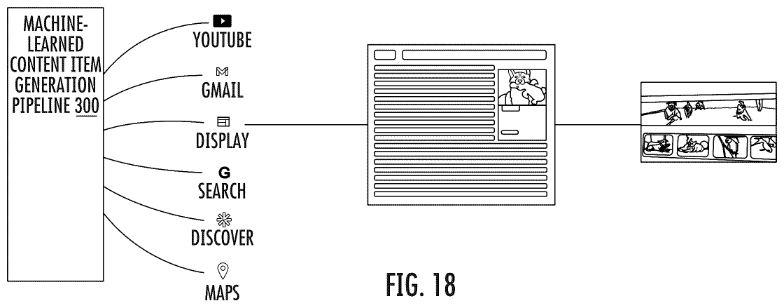

FIG. 18 illustrates an example data flow for generating a variety of content items for a variety of distribution mechanisms. The content items can be configured to cause, responsive to an interaction, loading of a data resource (e.g., data resource 110).

### Example Devices and Systems

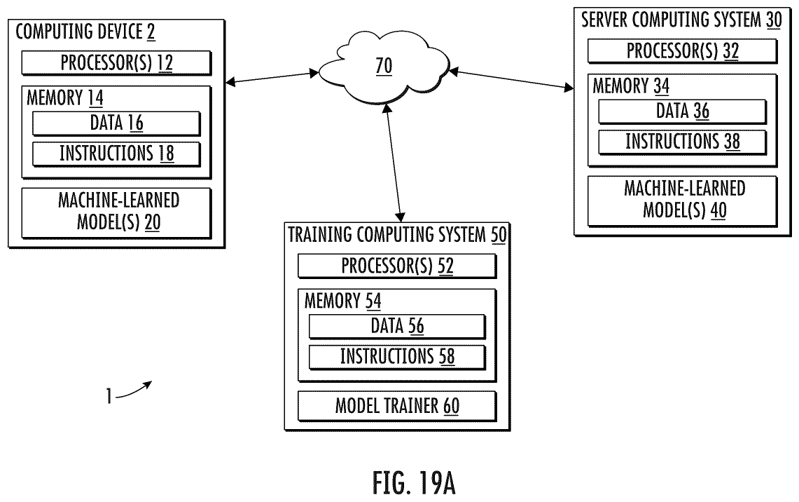

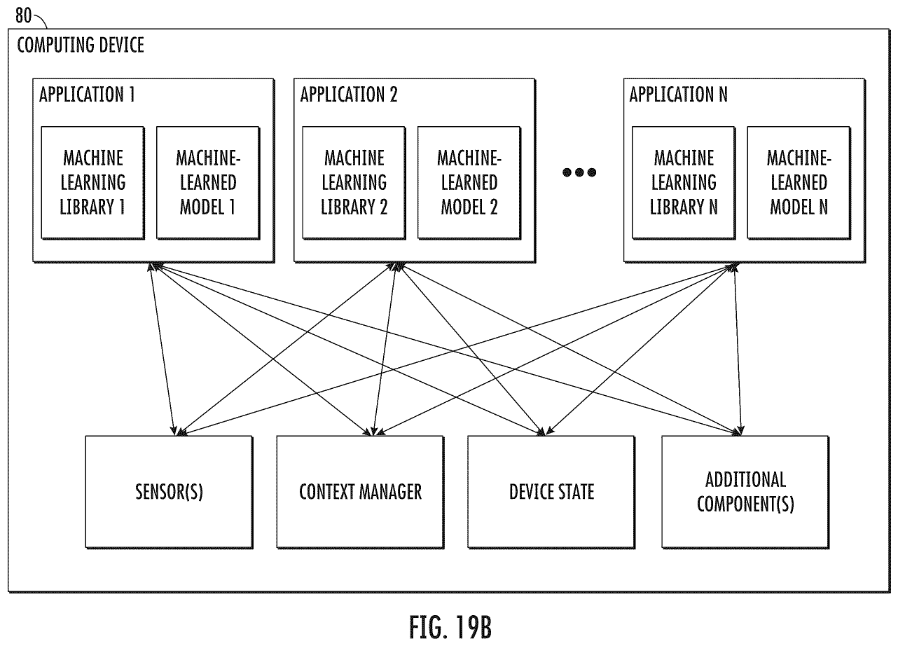

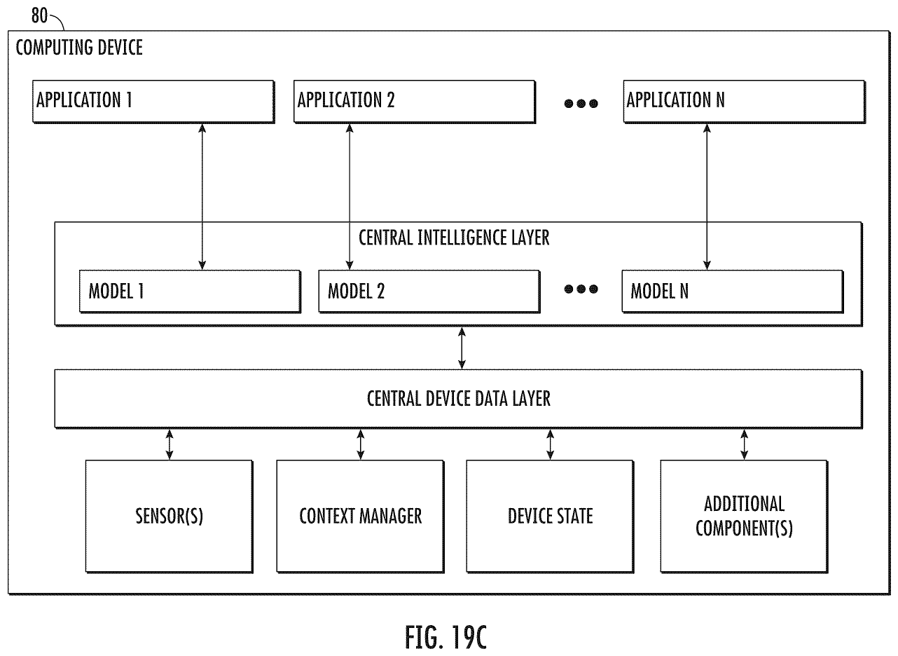

FIG. 19A depicts a block diagram of an example computing system 1 that can perform according to example embodiments of the present disclosure. The system 1 includes a computing device 2, a server computing system 30, and a training computing system 50 that are communicatively coupled over a network 70.

The computing device 2 can be any type of computing device, such as, for example, a personal computing device (e.g., laptop or desktop), a mobile computing device (e.g., smartphone or tablet), a gaming console or controller, a wearable computing device, an embedded computing device, or any other type of computing device. In some embodiments, the computing device 2 can be a client computing device. The computing device 2 can include one or more processors 12 and a memory 14. The one or more processors 12 can be any suitable processing device (e.g., a processor core, a microprocessor, an ASIC, an FPGA, a controller, a microcontroller) and can be one processor or a plurality of processors that are operatively connected. The memory 14 can include one or more non-transitory computer-readable storage media, such as RAM, ROM, EEPROM, EPROM, flash memory devices, magnetic disks, and combinations thereof. The memory 14 can store data 16 and instructions 18 which are executed by the processor 12 to cause the user computing device 2 to perform operations (e.g., to perform operations implementing input data structures and self-consistency output sampling according to example embodiments of the present disclosure).

In some implementations, the user computing device 2 can store or include one or more machine-learned models 20. For example, the machine-learned models 20 can be or can otherwise include various machine-learned models such as neural networks (e.g., deep neural networks) or other types of machine-learned models, including non-linear models or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, one or more machine-learned models 20 can be received from the server computing system 30 over network 70, stored in the computing device memory 14, and used or otherwise implemented by the one or more processors 12. In some implementations, the computing device 2 can implement multiple parallel instances of a machine-learned model 20.

Additionally, or alternatively, one or more machine-learned models 40 can be included in or otherwise stored and implemented by the server computing system 30 that communicates with the computing device 2 according to a client-server relationship.

Machine-learned model(s) 20 and 40 can include any one or more of the machine-learned models described herein, including the machine-learned asset generation pipeline and any of the component models therein.

The machine-learned models described in this specification may be used in a variety of tasks, applications, and/or use cases. Although described throughout with respect to example implementations for applications in medical domains, it is to be understood that the techniques described herein may be used for other tasks in various technological fields.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data). As another example, the machine-learned model(s) can process the image data to generate an encoded image data output (e.g., an encoded and/or compressed representation of the image data). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data). As another example, the machine-learned model(s) can process the speech data to generate an upscaled speech output (e.g., speech data that is higher quality than the input speech data). As another example, the machine-learned model(s) can process the speech data to generate a textual representation output (e.g., a textual representation of the input speech data). As another example, the machine-learned model(s) can process the speech data to generate a prediction output.

In some implementations, the input to the machine-learned model(s) of the present disclosure can be latent encoding data (e.g., a latent space representation of an input). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some embodiments, the machine-learned models 40 can be implemented by the server computing system 30 as a portion of a web service (e.g., remote machine-learned model hosting service, such as an online interface for performing machine-learned model operations over a network on remote servers 30). For instance, the server computing system 30 can communicate with the computing device 2 over a local intranet or internet connection. For instance, the computing device 2 can be a workstation or endpoint in communication with the server computing system 30, with implementation of the model 40 on the server computing system 30 being remotely performed and an output provided (e.g., cast, streamed) to the computing device 2. Thus, one or more models 20 can be stored and implemented at the user computing device 2 or one or more models 40 can be stored and implemented at the server computing system 30.

The computing device 2 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the computing device 2 is a user endpoint associated with a user account of a campaign generation system. The campaign generation system can operate on the server computing system 30.

The server computing system 30 can include one or more processors 32 and a memory 34. The one or more processors 32 can be any suitable processing device (e.g., a processor core, a microprocessor, an ASIC, an FPGA, a controller, a microcontroller) and can be one processor or a plurality of processors that are operatively connected. The memory 34 can include one or more non-transitory computer-readable storage media, such as RAM, ROM, EEPROM, EPROM, flash memory devices, magnetic disks, and combinations thereof. The memory 34 can store data 36 and instructions 38 which are executed by the processor 32 to cause the server computing system 30 to perform operations.

In some implementations, the server computing system 30 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 30 can store or otherwise include one or more machine-learned models 40. For example, the models 40 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The computing device 2 or the server computing system 30 can train example embodiments of a machine-learned model (e.g., including models 20 or 40) using a training pipeline (e.g., an unsupervised pipeline, a semi-supervised pipeline). In some embodiments, the computing device 2 or the server computing system 30 can train example embodiments of a machine-learned model (e.g., including models 20 or 40) using a pre-training pipeline by interaction with the training computing system 50. In some embodiments, the training computing system 50 can be communicatively coupled over the network 70. The training computing system 50 can be separate from the server computing system 30 or can be a portion of the server computing system 30.

The training computing system 50 can include one or more processors 52 and a memory 54. The one or more processors 52 can be any suitable processing device (e.g., a processor core, a microprocessor, an ASIC, an FPGA, a controller, a microcontroller) and can be one processor or a plurality of processors that are operatively connected. The memory 54 can include one or more non-transitory computer-readable storage media, such as RAM, ROM, EEPROM, EPROM, flash memory devices, magnetic disks, and combinations thereof. The memory 54 can store data 56 and instructions 58 which are executed by the processor 52 to cause the training computing system 50 to perform operations (e.g., to perform operations implementing input data structures and self-consistency output sampling according to example embodiments of the present disclosure). In some implementations, the training computing system 50 includes or is otherwise implemented by one or more server computing devices.

The model trainer 60 can include a training pipeline for training machine-learned models using various objectives. Parameters of the image-processing model(s) can be trained, in some embodiments, using various training or learning techniques, such as, for example, backwards propagation of errors. For example, an objective or loss can be back propagated through the pretraining pipeline(s) to update one or more parameters of the model(s) (e.g., based on a gradient of the loss function). Various determinations of loss can be used, such as mean squared error, likelihood loss, cross entropy loss, hinge loss, or various other loss functions. Gradient descent techniques can be used to iteratively update the parameters over a number of training iterations. In some implementations, performing backwards propagation of errors can include performing truncated backpropagation through time. The pretraining pipeline can perform a number of generalization techniques (e.g., weight decays, dropouts) to improve the generalization capability of the models being trained.

The model trainer 60 can train one or more machine-learned models 20 or 40 using training data (e.g., data 56). The training data can include, for example, historical performance data, past user interactions, and/or past campaigns.

The model trainer 60 can include computer logic utilized to provide desired functionality. The model trainer 60 can be implemented in hardware, firmware, or software controlling a general-purpose processor. For example, in some implementations, the model trainer 60 includes program files stored on a storage device, loaded into a memory, and executed by one or more processors. In other implementations, the model trainer 60 includes one or more sets of computer-executable instructions that are stored in a tangible computer-readable storage medium such as RAM, hard disk, or optical or magnetic media.

The network 70 can be any type of communications network, such as a local area network (e.g., intranet), wide area network (e.g., Internet), or some combination thereof and can include any number of wired or wireless links. In general, communication over the network 70 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

FIG. 19A illustrates one example computing system that can be used to implement the present disclosure. Other computing systems can be used as well. For example, in some implementations, the computing device 2 can include the model trainer 60. In some implementations, the computing device 2 can implement the model trainer 60 to personalize the model(s) based on device-specific data.

FIG. 19B depicts a block diagram of an example computing device 80 that performs according to example embodiments of the present disclosure. The computing device 80 can be a user computing device or a server computing device. The computing device 80 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, and a browser application. As illustrated in FIG. 19B, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 19C depicts a block diagram of an example computing device 80 that performs according to example embodiments of the present disclosure. The computing device 80 can be a user computing device or a server computing device. The computing device 80 can include a number of applications (e.g., applications 1 through N). Each application is in communication with a central intelligence layer. Example applications include a text messaging application, an email application, a dictation application, a virtual keyboard application, and a browser application. In some implementations, each application can communicate with the central intelligence layer (and model(s) stored therein) using an API (e.g., a common API across all applications).

The central intelligence layer can include a number of machine-learned models. For example, as illustrated in FIG. 19C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 80.

The central intelligence layer can communicate with a central device data layer. The central device data layer can be a centralized repository of data for the computing device 80. As illustrated in FIG. 19C, the central device data layer can communicate with a number of other components of the computing device, such as, for example, one or more sensors, a context manager, a device state component, or additional components. In some implementations, the central device data layer can communicate with each device component using an API (e.g., a private API).

### Example Methods

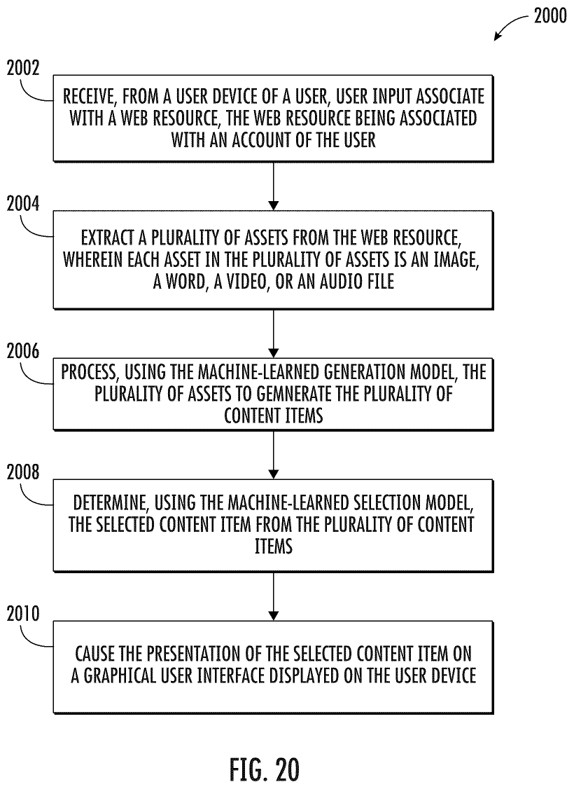

FIG. 20 depicts a flow chart diagram of an example method 2000 to perform according to example embodiments of the present disclosure. Example method 2000 can be implemented by one or more computing systems (e.g., one or more computing systems as discussed with respect to FIGS. 1 to 19C). Although FIG. 6 depicts steps performed in a particular order for purposes of illustration and discussion, the methods of the present disclosure are not limited to the particularly illustrated order or arrangement. The various steps of the method 2000 can be omitted, rearranged, combined, and/or adapted in various ways without deviating from the scope of the present disclosure.

At 2002, a computing system can receive, from a user device of a user, user input associated with a web resource, the web resource being associated with an account of the user.

At 2004, the computing system can extract a plurality of assets from the web resource, wherein each asset in the plurality of assets is an image, a word, a video, or an audio file.

At 2006, the computing system can process, using the machine-learned generation model, the plurality of assets to generate the plurality of content items.

At 2008, the computing system can determine, using the machine-learned selection model, the selected content item from the plurality of content items.

At 2010, the computing system can cause the presentation of the selected content item on a graphical user interface displayed on the user device.

In some instances, the operations can further include receiving a user interaction on the graphical user interface, the user interaction modifying the selected content item. Additionally, the operations can include processing, using the machine-learned generation model, the user interaction, and the selected content item to generate a modified content item. Moreover, the operations can include causing the presentation of the modified content item on the graphical user interface displayed on the user device. Furthermore, one or more parameters of the machine-learned generation model can be updated based on the user interaction.

In some instances, the operations can further include receiving a user interaction on the graphical user interface. The user interaction can be associated with rejecting the selected content item. Additionally, the operations can include processing, using the machine-learned selection model, the plurality of content items and the user interaction to generate a new content item. Moreover, the operations can include causing the presentation of the new content item on the graphical user interface displayed on the user device.

In some instances, the operations can further include receiving a user interaction on the graphical user interface, the user interaction accepting the selected content item. Additionally, the operations can include determining, using a machine-learned model, an advertisement campaign based on the selected content item. Moreover, the operations can include causing the presentation of the advertisement campaign on the graphical user interface displayed on the user device.

In some instances, the web resource can be a website, and the user input is a Uniform Resource Locator (URL) of the website.

In some instances, the plurality of content items can include a first content item, and the first content item can be generated by modifying an image asset of the plurality of assets. Additionally, the plurality of content items can include a second content item, and the second content item is a generative image generated by the machine-learned generation model using the image asset.

In some instances, the operations can further include calculating, using the machine-learned selection model, a conversion score for each content item in the plurality of content items, the conversion score indicating the likelihood that a user interacts with the respective content item. For example, the selected content item can be the content item with the highest conversion score in the plurality of content items.

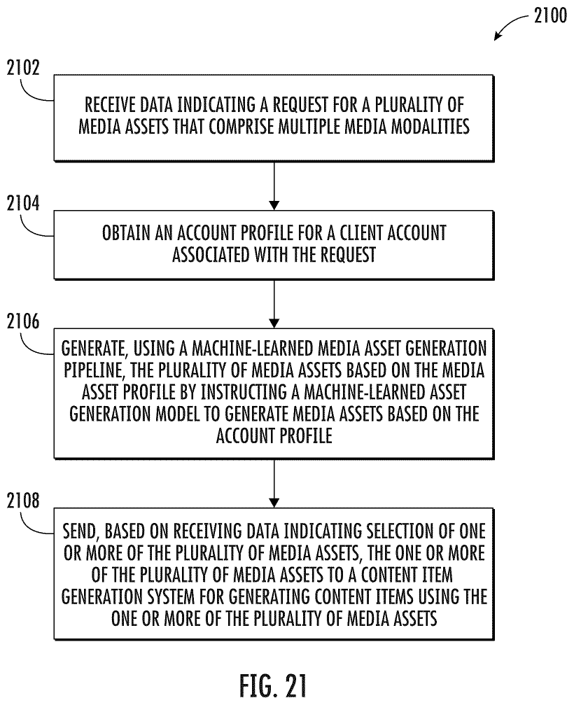

FIG. 21 depicts a flow chart diagram of an example method 2100 to perform according to example embodiments of the present disclosure. Although FIG. 21 depicts steps performed in a particular order for purposes of illustration and discussion, the methods of the present disclosure are not limited to the particularly illustrated order or arrangement. The various steps of the method 2100 can be omitted, rearranged, combined, and/or adapted in various ways without deviating from the scope of the present disclosure.

At 2102, a computing system can receive data indicating a request for a plurality of media assets that comprise multiple media modalities.

At 2104, the computing system can obtain a media asset profile for a client account associated with the request, wherein the media asset profile comprises data indicating media asset preferences for the client account, and wherein the media asset profile was generated by processing pre-existing media assets associated with the client account.

At 2106, the computing system can generate, using a machine-learned media asset generation pipeline, the plurality of media assets based on the media asset profile by instructing a machine-learned asset generation model to generate media assets that align with the media asset preferences.

At 2108, the computing system can send, based on receiving data indicating selection of one or more of the plurality of media assets, the one or more of the plurality of media assets to a content item generation system for generating content items using the one or more of the plurality of media assets.

In some instances, the multiple media modalities include two or more modalities selected from: text, image, or audio.

In some instances, the operations can further include generating data for the media asset profile by parsing a web resource associated with the client account.

In some instances, the operations can further include parsing the web resource to extract the pre-existing media assets from the web resource.

In some instances, the operations can further include parsing the web resource to extract visual style data associated with the client account. For example, the visual style can include color information, layout information, or typography information.

In some instances, the operations can further include parsing the web resource to extract textual style data associated with the client account. The textual style data can include an intonation or inflection of copy on the web resource.

In some instances, the operations can further include parsing the web resource to extract landing page data associated with the client account. The landing page data can include URLs to web pages associated with the plurality of media assets.

In some instances, the media asset profile was retrieved from a database, and the media asset profile was previously generated prior to the request.

In some instances, the operations can further include generating at least one of the plurality of media assets by editing a pre-existing image asset using at least one of the following editing operations: crop, rotate, infill, recolor, defocus, deblur, denoise, relight. The editing operations are optionally implemented with machine-learned image editing tools. Additionally the pre-existing image asset can be edited based on historical performance data associated with image assets. Moreover, the pre-existing image asset can be edited based on a set of content item guidelines for generating content items using the pre-existing image asset.

In some instances, the operations can further include inputting, to a machine-learned media asset generation model, data from the media asset profile and a request for generated assets consistent with the data from the media asset profile.

In some instances, the operations can further include determining, using a machine-learned performance estimation model, one or more generated assets, wherein the machine-learned performance estimation model is configured to identify asset characteristics associated with historical performance data. Additionally, the operations can further include generating, using the machine-learned performance estimation model, an augmented input for input to the machine-learned media asset generation model to induce asset characteristics associated with historical performance data. Moreover, the operations can include ranking, using the machine-learned performance estimation model, the generated assets from the machine-learned media asset generation model.

In some instances, the operations can further include presenting, on a user interface accessible by the client account, one or more generated media assets for review. Additionally, the operations can include receiving, via the user interface, inputs providing corrections to the one or more generated media assets. Moreover, the operations can include re-generating, using the machine-learned media asset generation pipeline, the one or more generated media assets based on the received inputs. Furthermore, the user interface can include one or more selectable input elements associated with the one or more generated media assets and indicating a corresponding corrective action to be performed with respect to the one or more generated media assets. The selectable input elements can be configured to provide, upon selection, the received inputs. The user interface can include a natural language input element for receiving corrective inputs in natural language format, where the natural language input element is configured to provide the received inputs.

In some instances, the media asset profile can be based on at one or more features of the following features, the one or more features being associated with the client account: a machine-learned model, images, sitemap, logo, social media accounts, asset library, performance data, past sets of media assets, past sets of generated media assets.

In some instances the plurality of media assets can include two or more categories of the following categories: images, headlines, descriptions, videos, logos, colors, sitelinks, calls to action, audio.

### ADDITIONAL DISCLOSURE

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example of how implementations can operate or be configured is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but.” It should be understood that such conjunctions are provided for explanatory purposes only. Clauses and other sequences of items joined by a particular conjunction such as “or,” for example, can refer to “and/or,” “at least one of,” “any combination of” example elements listed therein. Also, terms such as “based on” should be understood as “based at least in part on.”

What is claimed is:

1. A computer-implemented method, comprising:
receiving data indicating a request for a plurality of media assets that comprise multiple media modalities;
obtaining a data resource locator indicating a data resource;
parsing the data resource to obtain pre-existing media assets;
receiving one or more control signals;
generating, using a machine-learned media asset generation pipeline, the plurality of media assets based on the one or more control signals by instructing a machine-learned asset generation model to generate media assets that align with the one or more control signals; and
sending, based on receiving data indicating selection of one or more of the plurality of media assets, the one or more of the plurality of media assets to a content item generation system for generating content items using the one or more of the plurality of media assets.

2. The method of claim 1, wherein generating, using the machine-learned media asset generation pipeline, the plurality of media assets based on the one or more control signals comprises, for each respective modality of the multiple media modalities:
instructing a respective machine-learned asset generation model associated with the respective modality to generate respective media assets that align with the one or more control signals.

3. The method of claim 1, wherein the multiple media modalities include two or more modalities selected from: text, image, or audio.

4. The method of claim 1, wherein the request is associated with a client account, and wherein the client account is associated with an account profile storing inputs to the machine-learned media asset generation pipeline.

5. The method of claim 4, wherein the account profile was retrieved from a database, and wherein the account profile was previously generated prior to the request.

6. The method of claim 1, comprising:
parsing a web resource to extract visual style data associated with a client account, the visual style comprising color information, layout information, or typography information.

7. The method of claim 1, comprising:
parsing a web resource to extract textual style data associated with a client account, the textual style data comprising an intonation or inflection of copy on the web resource.

8. The method of claim 1, comprising:
parsing a web resource to extract landing page data associated a client account, wherein the landing page data comprises URLs to web pages associated with the plurality of media assets.

9. The method of claim 1, comprising:
generating at least one of the plurality of media assets by editing a pre-existing image asset using at least one of the following editing operations: crop, rotate, infill, recolor, defocus, deblur, denoise, relight; and
wherein the editing operations are optionally implemented with machine-learned image editing tools.

10. The method of claim 9, wherein the pre-existing image asset is edited based on historical performance data associated with related image assets, and wherein the pre-existing image asset is edited based on a set of content item guidelines for generating content items using the pre-existing image asset.

11. The method of claim 1, comprising:
inputting, to a machine-learned media asset generation model, data from an account profile and a request for generated assets consistent with the data from the profile;

12. The method of claim 1, comprising:
determining, using a machine-learned performance estimation model, one or more generated assets, wherein the machine-learned performance estimation model is configured to identify asset characteristics associated with historical performance data;
generating, using the machine-learned performance estimation model, an augmented input for input to the machine-learned media asset generation model to induce asset characteristics associated with historical performance data by changing a prompt input to the machine-learned media asset generation model; and
ranking, using the machine-learned performance estimation model, the generated assets from the machine-learned media asset generation model by using a machine-learned ranking model to rank assets based on an estimated performance of the asset.

13. The method of claim 1, comprising:
presenting, on a user interface accessible by a client account, one or more generated media assets for review;
receiving, via the user interface, inputs providing corrections to the one or more generated media assets; and
re-generating, using the machine-learned media asset generation pipeline, the one or more generated media assets based on the received inputs.

14. The method of claim 1, wherein a media asset profile is based on at one or more features of the following features, the one or more features being associated with a client account: a machine-learned model, images, sitemap, logo, social media accounts, asset library, performance data, past sets of media assets, past sets of generated media assets.

15. The method of claim 1, wherein the machine-learned media asset generation pipeline comprises a plurality of machine-learned media generators, a machine-learned optimizer, and a machine-learned ranker.

16. The method of claim 1, wherein the machine-learned media asset generation pipeline receives, via an asset feedback layer, inputs from a user to guide updates to or regeneration of at least one of the plurality of media assets.

17. The method of claim 1, wherein the machine-learned media asset generation pipeline receives, via a control layer, initial inputs from a user to guide generation of the plurality of media assets.

18. The method of claim 1, comprising:
updating an account profile based on:
(i) user inputs from a control layer;
(ii) user feedback from an asset feedback layer, including asset selections, rejections/removals, manual edits/adjustments, corrections, and other inputs;
(iii) pre-existing assets parsed from the data resource; or
(iv) features generated from any one or combinations of (i)-(iii), including brand personality features, theme features, style features.

19. One or more non-transitory, computer readable media storing instructions that are executable by one or more processors to cause a computing system to perform operations, the operations comprising:
receiving data indicating a request for a plurality of media assets that comprise multiple media modalities;
obtaining a data resource locator indicating a data resource;
parsing the data resource to obtain pre-existing media assets;
receiving one or more control signals;
generating, using a machine-learned media asset generation pipeline, the plurality of media assets based on the one or more control signals by instructing a machine-learned asset generation model to generate media assets that align with the one or more control signals; and
sending, based on receiving data indicating selection of one or more of the plurality of media assets, the one or more of the plurality of media assets to a content item generation system for generating content items using the one or more of the plurality of media assets.

20. A computing system comprising:
one or more processors; and
one or more transitory or non-transitory computer-readable media storing instructions that are executable to cause the one or more processors to perform operations, the operations comprising:
receiving data indicating a request for a plurality of media assets that comprise multiple media modalities;
obtaining a data resource locator indicating a data resource;
parsing the data resource to obtain pre-existing media assets;
receiving one or more control signals;
generating, using a machine-learned media asset generation pipeline, the plurality of media assets based on the one or more control signals by instructing a machine-learned asset generation model to generate media assets that align with the one or more control signals; and
sending, based on receiving data indicating selection of one or more of the plurality of media assets, the one or more of the plurality of media assets to a content item generation system for generating content items using the one or more of the plurality of media assets.
